(19) United States
(12) Patent Application Publication
(10) Pub. No.: US 2014/0077992 A1
(43) Pub. Date: Mar. 20, 2014

(54) GNSS SYSTEM AND METHOD USING UNBIASED CODE PHASE TRACKING WITH INTERLEAVED PSEUDO-RANDOM CODE

(71) Applicant: Hemisphere GNSS Inc., Scottsdale, AZ (US)

(72) Inventors: Junjie Liu, Scottsdale, AZ (US); Bradley P. Badke, Chandler, AZ (US)

(73) Assignee: Hemisphere GNSS Inc., Scottsdale, AZ (US)

(21) Appl. No.: 13/966,142

(22) Filed: Aug. 13, 2013

Related U.S. Application Data
(60) Provisional application No. 61/702,031, filed on Sep. 17, 2012.

(51) Int. Cl. G01S 19/31

(52) U.S. Cl. CPC G01S 19/31
USPC 342/357.71

(57) ABSTRACT

Global Navigation Satellite System (GNSS) signals are first received and then down converted to an intermediate frequency (IF) and digitally sampled. The sampled signals are multiplied by a local replica of the incoming IF carrier (I ref generator and Q ref generator). The purpose is to remove the Doppler and move the results to baseband for later accumulation processing. Two parallel correlation kernel modules, one kernel assuming the navigation data D is 1 while the other assuming navigation data D=0 or (−1), are provided. The correlation kernel takes the code numerically-controlled oscillator (nco) phase of the prompt signal as input, and generates four output signals that are multiplied by the Doppler-removed incoming sample signal. An implementation of the pulsed signals accommodates navigation data D=1 and D=0 or (−1).

### CROSS-REFERENCE TO RELATED APPLICATIONS

This application claims priority in U.S. Provisional Patent Application No. 61/702,031, filed Sep. 17, 2012, which is incorporated herein by reference.

### BACKGROUND OF THE INVENTION

1. Field of the Invention

The present invention relates generally to global navigation satellite system (GNSS) receiver technology, and in particular to the use of parallel correlation kernel modules and tracking signals, such as L2C, for robustness and improving GNSS-based positioning, particularly during receiver operation outages, weak signals and other conditions affecting receiver performance.

2. GNSS Background Description of the Related Art

Global navigation satellite systems (GNSSs) include the Global Positioning System (GPS), which was established and is operated by the United States government and employs a constellation of 24 or more satellites in well-defined orbits at an altitude of approximately 20,200 km. These satellites continually transmit microwave L-band radio signals in three frequency bands, centered at 1575.42 MHz, 1227.60 MHz and 1176.45 MHz, denoted as L1, L2 and L5 respectively. All GNSS signals include timing patterns relative to the satellite's onboard precision clock (which is kept synchronized by a ground station) as well as a navigation message giving the precise orbital positions of the satellites. GPS receivers process the radio signals, computing ranges to the GPS satellites, and by triangulating these ranges, the GPS receiver determines its position and its internal clock error. Different levels of accuracies can be achieved depending on the observables used and the correction techniques employed. For example, accuracy within about 2 cm can be achieved using real-time kinematic (RTK) methods with single or dual-frequency (L1 and L2) receivers.

GNSS also includes Galileo (Europe), the GLObal NAvigation Satellite System (GLONASS, Russia), Beidou (China), Compass (proposed), the Indian Regional Navigational Satellite System (IRNSS) and QZSS (Japan, proposed). Galileo will transmit signals centered at 1575.42 MHz, denoted L1 or E1, 1176.45 denoted E5a, 1207.14 MHz, denoted E5b, 1191.795 MHz, denoted E5 and 1278.75 MHz, denoted E6. GLONASS transmits groups of FDM signals centered approximately at 1602 MHz and 1246 MHz, denoted GL1 and GL2 respectively. QZSS will transmit signals centered at L1, L2, L5 and E6. Groups of GNSS signals are herein grouped into “superbands.”

To gain a better understanding of the accuracy levels achievable by using GNSS, it is necessary to understand the types of signals available from the GNSS satellites. One type of signal includes both the coarse acquisition (C/A) code, which modulates the L1 radio signal, and the precision (P) code, which modulates both the L1 and L2 radio signals. These are pseudorandom digital codes that provide a known pattern that can be compared to the receiver's version of that pattern. By measuring the time-shift required to align the pseudorandom digital codes, the GNSS receiver is able to compute an unambiguous pseudo-range to the satellite. Both the C/A and P codes have a relatively long “wavelength,” of about 300 meters (1 microsecond) and 30 meters ( 1/10 microsecond), respectively. Consequently, use of the C/A code and the P code yield position data only at a relatively coarse level of resolution.

The second type of signal utilized for position determination is the carrier signal. The term “carrier,” as used herein, refers to the dominant spectral component which remains in the radio signal after the spectral content caused by the modulated pseudorandom digital codes (C/A and P) is removed. The L1 and L2 carrier signals have wavelengths of about 19 and 24 centimeters, respectively. The GNSS receiver is able to “track” these carrier signals, and in doing so, make measurements of the carrier phase to a small fraction of a complete wavelength, permitting range measurement to an accuracy of less than a centimeter.

In stand-alone GNSS systems that determine a receiver's position coordinates without reference to a nearby reference receiver, the process of position determination is subject to errors from a number of sources. These include errors in the satellite's clock reference, the location of the orbiting satellite, ionospheric-induced propagation delay errors, and tropospheric refraction errors. A more detailed discussion of these sources of error is provided in U.S. Pat. No. 5,828,336 by Yunck, et al.

To overcome the errors of stand-alone GNSS, many kinematic positioning applications make use of multiple GNSS receivers. A reference receiver located at a reference site having known coordinates receives the satellite signals simultaneously with the receipt of signals by a remote receiver. Depending on the separation distance, many of the errors mentioned above will affect the satellite signals equally for the two receivers. By taking the difference between signals received both at the reference site and at the remote location, these errors are effectively eliminated. This facilitates an accurate determination of the remote receiver's coordinates relative to the reference receiver's coordinates. The technique of differencing signals is known in the art as differential GNSS (DGNSS). The combination of DGNSS with precise measurements of carrier phase leads to position accuracies of less than one centimeter root-mean-squared (centimeter-level positioning). When DGNSS positioning utilizing carrier phase is done in real-time while the remote receiver is potentially in motion, it is often referred to as Real-Time Kinematic (RTK) positioning.

One method, which effectively gives more measurements in a GPS system, is to use dual frequency (DF) receivers for tracking delta-range measurements from P code modulation on the L1 and L2 carriers simultaneously with the L1 C/A code generating code phase measurements. The L1 and L2 carriers are modulated with codes that leave the GNSS satellite at the same time. Since the ionosphere produces different delays for radio carriers of different frequencies, such dual frequency receivers can be used to obtain real-time measurements of ionospheric delays at various receiver positions. The L1 and L2 ranging measurements are combined to create a new L1 ranging measurement that has an ionospheric delay of the same sign as the ionosphere delay in the L1 pseudorange. Accurate ionospheric delay information, when used in a position solution, can help produce more accuracy. Absent such real-time ionospheric delay measurements, other correction techniques are commonly used, such as differential GNSS (DGNSS), proprietary third party satellite augmentation system (SAS) services available on a paid subscription basis, or the U.S.-sponsored Wide Area Augmentation System (WAAS). Similar methods and corresponding equipment configurations can be used for other GNSS systems, including those identified above.

As compared to single-frequency (typically L1) receiver systems, previous dual-frequency receiver systems have tended to be relatively expensive because of their additional components for accommodating L2 measurements. Moreover, the additional components tended to consume more power and required additional space. Still further, dual-frequency receivers should be adaptable for use with all present and projected GNSS, transmitting signals which can be grouped into two “superbands” of radio signal frequencies generally in the range of about 1160 MHz to 1250 MHz and 1525 MHz to 1613 MHz. Accordingly, a preferred multi-frequency receiver should be: a single, application-specific integrated circuit (ASIC); programmable for down converting various pairs of frequencies; minimally-sized; and capable of operating with minimal power. For example and without limitation on the generality of components usable with the present invention, a suitable ASIC is shown and described in U.S. Pat. No. 8,217,833, which is assigned to a common or jointly-owned assignee and incorporated herein by reference.

The United States' Global Positioning System (GPS) first reached fully operational capability on Jul. 17, 1995. After almost two decades, advances in technology and new demands have prompted efforts to modernize the GPS system. Part of the modernization are new civilian navigation signals to be transmitted on a frequency other than the L1 frequency (1575.42 MHz). This signal became known as the L2C signal because it is a civilian signal broadcast on the L2 frequency (1227.6 MHz). It is transmitted by all block IIR-M and newer generation satellites.

Whitehead et al. U.S. Pat. No. 6,744,404 shows an Unbiased Code Phase Estimator for Mitigating Multipath in GPS, and is incorporated herein by reference. U.S. Coast Guard Navigation Center, “GPS FAQ,” U.S. Department of Homeland Security; and Naystar Global Positioning System, “Interface Specification-ICD-GPS-200,” Naystar GPS Joint Program Office are also incorporated herein by reference.

### SUMMARY OF THE INVENTION

This invention relates to the tracking algorithm related to the new L2C signal. More specifically, two parallel correlation kernel modules are utilized for simultaneous processing based on unknown characteristics, such as positive and negative values of the navigation data bit D. Upon resolution of the sign of the navigation data bit D, a corresponding code phase and carrier phase discriminator is formed and sent to code and carrier phase tracking loops to drive the local replica to follow that of the incoming signals.

L2C simplifies dual frequency design significantly. Prior to L2C, there was no civilian code on the L2 frequency and only a military signal L2P existed on this frequency. The structure of L2P is known, however in order to deny unauthorized access to this military signal, the L2P is modulated by another unknown signal called Y code. The Y code complicates the design of civilian dual frequency receivers significantly. Semi-codeless or codeless technique has to be employed to track the L2P(Y) code, which cause performance degradation, especially in lower SNR scenarios. In contrast, the structure of the L2C code is completely known. The code noise performance of the L2C is expected to be similar to L1 C/A. An advantage of L2C over L1 C/A is that L2C has a pilot tone, which can be tracked with a pure phase lock loop, instead of a Costas loop. The former has a 6 dB tracking threshold advantage compared to a Costas tracking loop (which is the case of L1 C/A carrier). A robust L2 carrier tracking could aid other tracking loops, such as L2P, L1P and L1 C/A. It also brings frequency diversity to counter ionosphere scintillation effects, as deep fades are unlikely to occur at the same time for both L1 and L2. A receiver with L2C tracking will result in less receiver operation outage and more robust integrity.

### BRIEF DESCRIPTION OF THE DRAWINGS

FIG. 1 is a block diagram of a GPS satellite-based circuit for generating L2C signals.

FIG. 2 is a diagram of the L2C timing relationships.

FIG. 3a is a diagram of the L2C civilian long (CL) codes.

FIG. 3b is a diagram of the L2C civilian medium (CDM) codes.

FIG. 4 is a diagram of the L2C codes showing data dependency.

FIGS. 5a and 5b show a block diagram of a composite code detection system with multi-path mitigation embodying an aspect of the present invention.

FIG. 6a is a diagram of the L2C code when navigation data D=1.

FIG. 6b is a diagram of the L2C code when navigation data D=0 or (−1).

### DETAILED DESCRIPTION OF THE PREFERRED EMBODIMENTS

### I. Introduction and Environment

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Certain terminology will be used in the following description for convenience in reference only and will not be limiting. For example, up, down, front, back, right and left refer to the invention as oriented in the view being referred to. The words “inwardly” and “outwardly” refer to directions toward and away from, respectively, the geometric center of the embodiment being described and designated parts thereof. Said terminology will include the words specifically mentioned, derivatives thereof and words of similar meaning

Global navigation satellite systems (GNSSs) are broadly defined to include the Global Positioning System (GPS, U.S.), Galileo (proposed, Europe), GLONASS (Russia), Beidou (China), Compass (proposed), the Indian Regional Navigational Satellite System (IRNSS), QZSS (Japan, proposed) and other current and future positioning technology using signals from satellites, with or without augmentation from terrestrial sources.

II. Unbiased Code Phase Tracking with Interleaved Pseudo-Random (PRN) Code, such as GPS L2C

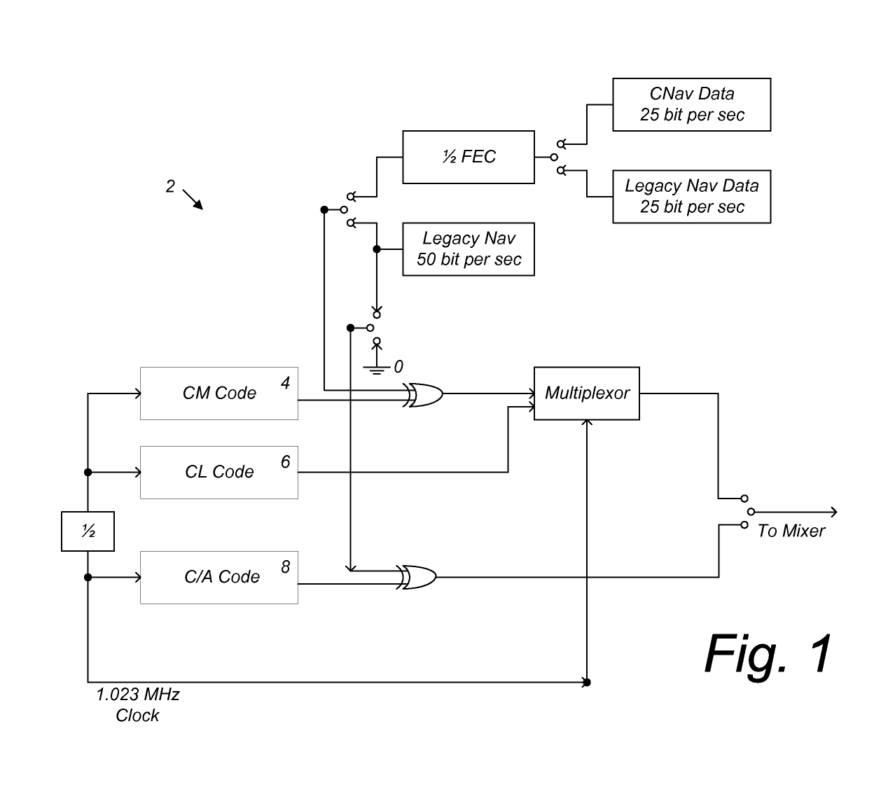

FIG. 1 illustrates an example of an on board satellite signal-generating circuit 2 for generating possible L2C signals. Without limitation on the generality of useful applications of the present invention, other signals and signal-generating circuits can also be used. The signal-generating circuit 2 includes a civilian moderate length code generator (CM) 4, a civilian long length code generator (CL) 6, and a coarse acquisition code generator (C/A) 8. There are four configurable options of the final transmitted L2C signals. For more information, see Naystar Global Positioning System, “Interface Specification-ICD-GPS-200,” Naystar GPS Joint Program Office. The configurable options are:

1) pure C/A code;

2) C/A XOR legacy navigation data;

3) CM XOR CNAV data with CL multiplexing; and

4) CM XOR legacy navigation data with CL multiplexing.

However, based on observations, pure C/A code and C/A XOR legacy navigation data (options 1 and 2 above) are not currently actively configured. Either option 3 or option 4 is currently active on the IIR-M satellites and L2C is time-multiplexed between two distinct PRN sequences:
1) civilian moderate (CM) length code is 10,230 chips in length, repeating every 20 milliseconds; and
2) civilian long (CL) length code is 767,250 chips in length, repeating every 1500 milliseconds.

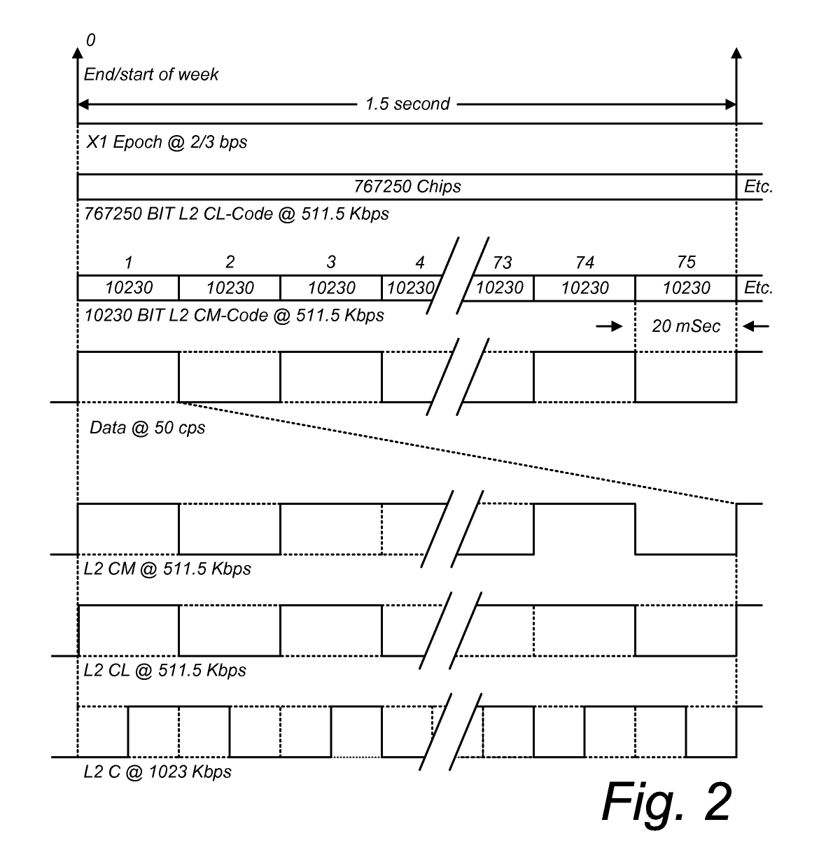

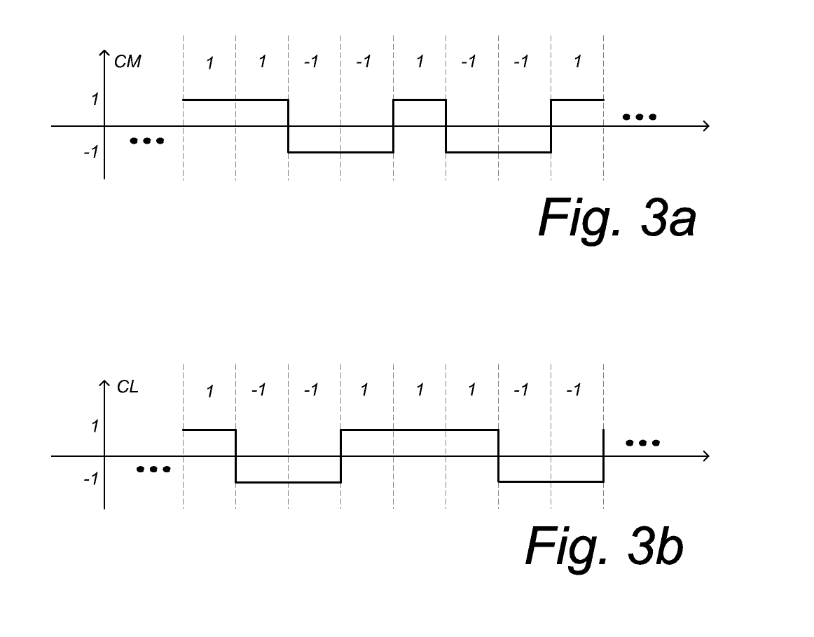

Both CM and CL codes are clocked at 511,500 chips per second. The general timing of the L2C code is shown in FIG. 2. FIGS. 3a and 3b show L2C civilian long (CL) and civilian medium (CM) codes respectively. The composite L2C code has an equivalent chipping rate of 1,023,000 chips per second, which is equivalent to L1 C/A. CM is modulated with navigation data, while CL is dataless.

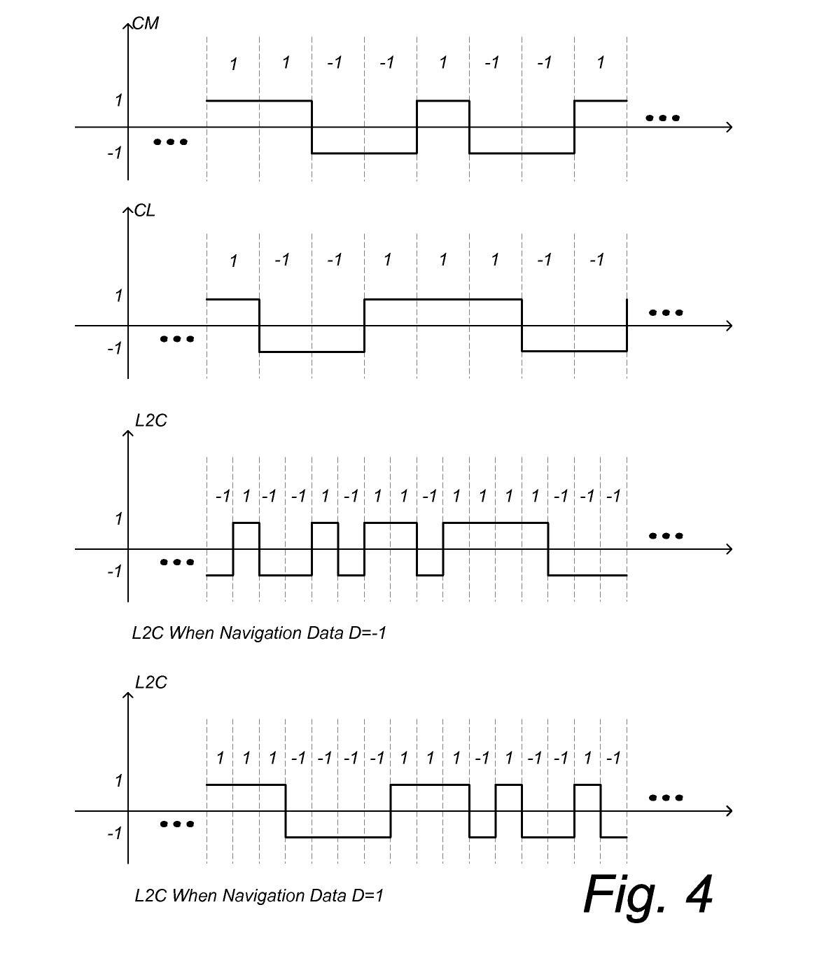

The data modulation of CM introduces complexity into the final composite L2C signal. Depending on the navigation data D, the L2C could have two possible waveforms as illustrated in FIG. 4.

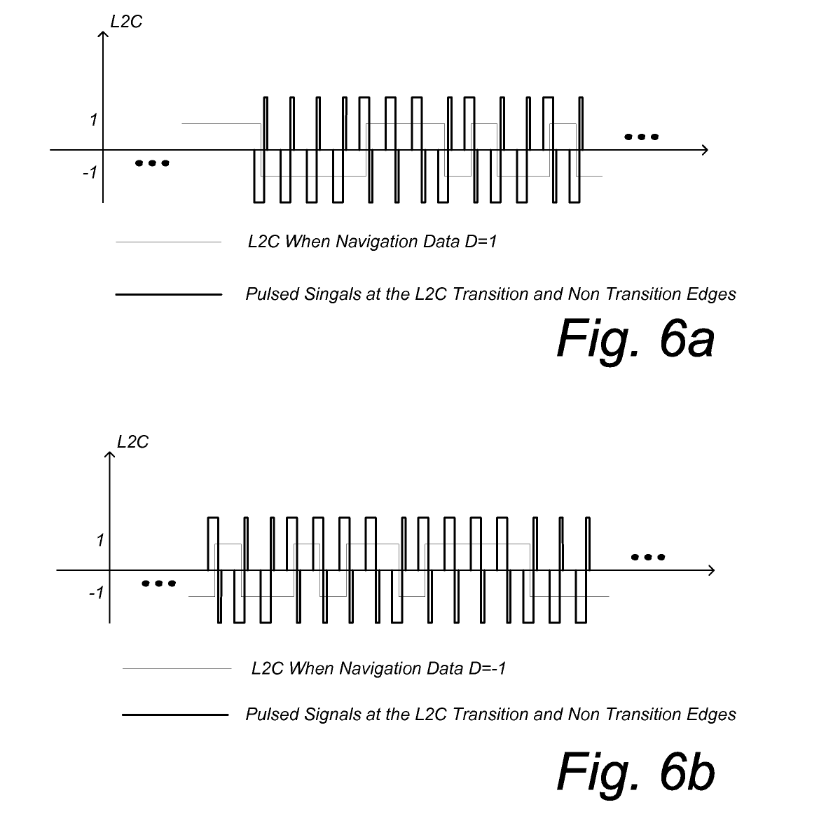

In a GNSS receiver, the sign of the navigation data D cannot be predicted. The two different L2C waveforms are equally likely, depending on navigation data D. In order to track the composite L2C signal, it is therefore necessary to have two parallel correlator kernels, with one assuming D=1 (FIG. 6a) while the other D=0 or (−1). Further, it is also possible to track the L2CL and L2CM signals independently, but it results in a 3 dB loss of signal strength. Tracking L2CL independently and increasing pre-detection integration time can compensate for this 3 dB loss, but in cases of high dynamics and multi-path it is desirable to track the composite signal.

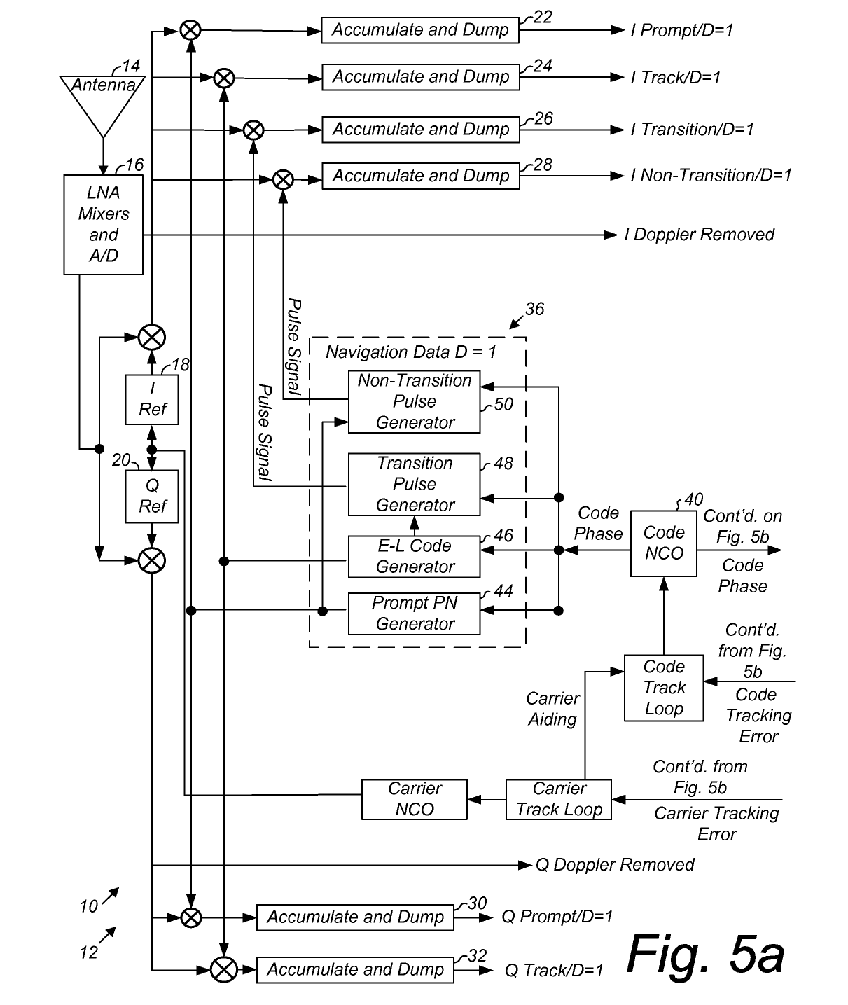

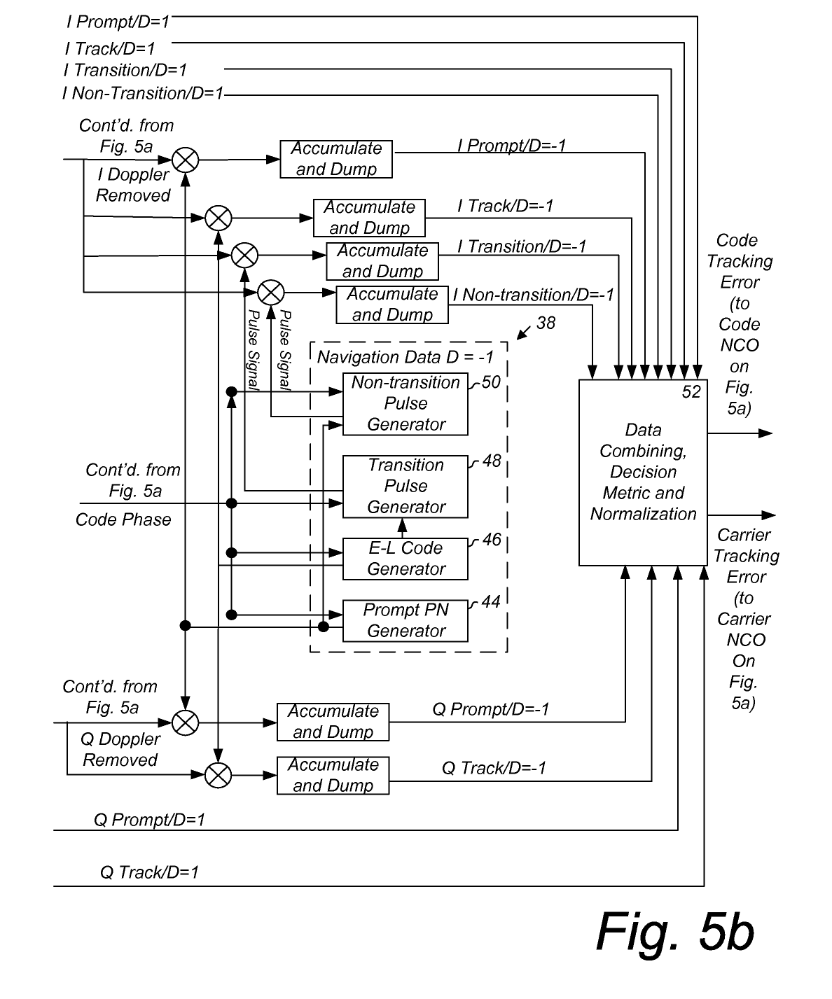

FIGS. 5a,b illustrate an aspect of the present invention comprising part of a system 10 for implementing parallel kernel tracking using composite code detection with multi-path mitigation. Without limitation, the part of the system 10 shown in FIGS. 5a, b can comprise the components of a GNSS receiver 12 implementing the unbiased code phase tracking of the present invention.

An antenna or antenna array 14 first receives the transmitted RF pseudo-random (PRN) encoded signals from one or more GNSS satellite constellation(s), e.g., GPS, Glonass, Galileo, etc. The PRN encoded signals are then down-converted, sampled and digitized in the LNA/mixer and analog-to-digital (A/D) converter 16 comprising an RF front end down convertor. The satellite signals are first received and then down-converted to an intermediate frequency (IF), and digitally sampled. The sampled signals are multiplied by a local replica of the incoming IF carrier (I ref generator 18 and Q ref generator 20). The purpose is to remove the Doppler and move the results to baseband for later accumulation processing. The digital output of the I and Q reference generators 18, 20 is connected to accumulator and dump components 22, 24, 26, 28, 30, 32 via frequency mixers (multipliers) 34.

At the core of the invention are two parallel correlation kernel modules 36, 38, one kernel 36 assuming the navigation data D=1 and the other kernel 38 assuming navigation data D=0 or (−1). The correlation kernels 36, 38 take the code numerically-controlled oscillator (nco) 40 phase of the prompt signal as input, and generate four output signals that are multiplied by the Doppler-removed incoming sample signal. The four output signals are: local prompt chip 44, early-late (E-L) chip 46, pulsed signal at the prompt chip transition edge 48, and pulsed signal at the prompt chip non-transition edge 50. For more information, see Whitehead U.S. Pat. No. 6,744,404, which is assigned to a common or commonly-owned assignee and incorporated herein by reference.

One implementation of the pulse signals is illustrated in FIGS. 6a and 6b with both navigation data D=1 and D=0 or (−1), depicting multipath mitigation pulsed signals with data dependency. For each correlation kernel 36, 38, there will be the following accumulate and dump results:
I_prompt, in phase portion of the correlation results between local prompt chip and Doppler-removed incoming signal sample

$${I}_{prompt} = [ R ( τ ) \sqrt{\frac{P}{2}} {D}_{tx} cos α + {n}_{{I}_{CM}} ] \times {D}_{rx} + R ( τ ) \sqrt{\frac{P}{2}} cos α + {n}_{I \_ CL} \qquad ( 1 )$$

Where:

R(τ) is the normalized correlation function of the CM/CL code, and τ is the delay between the local CM/CL code and that of the incoming. P is the received carrier power at the receiver front end, the ratio of ½ is because the carrier power is equally split between the CM and CL. Dₜₓ is the navigation data (1 or −1) as transmitted by the satellite, Dᵣₓ is the navigation data as assumed by one of the two correlation kernels. Dᵣₓ takes the value of 1 or −1. n_{I}_{_{—}}_{cm} is the noise resulting from the correlation of the local CM code against the incoming signal. n_{I}_{_{—}}_{CL} is the noise resulting from the correlation of the local CL code against the incoming signal, a is the phase error between the incoming carrier and the local replica carrier.

Q_prompt, quadrature portion of the correlation results between local prompt chip and Doppler-removed incoming signal sample, as below:

$${Q}_{prompt} = [ R ( τ ) \sqrt{\frac{P}{2}} {D}_{tx} sin α + {n}_{{Q}_{CM}} ] \times {D}_{rx} + R ( τ ) \sqrt{\frac{P}{2}} sin α + {n}_{Q \_ CL}$$

I_track, in phase portion of the correlation results between local E-L chip and Doppler-removed incoming signal sample, spacing between E and L is 1 chip.

Q_track, quadrature portion of the correlation results between local E-L chip and Doppler-removed incoming signal sample, spacing between E and L is 1 chip.

I_transition, in phase portion of the correlation results between local pulsed signal at the prompt chip transition edges and Doppler-removed incoming signal sample.

I_non-transition, in phase portion of the correlation results between local pulsed signal at the prompt chip non-transition edges and Doppler-removed incoming signal sample.

The results are sent to a decision metric 52 to validate which hypothesis is more likely than the other (D=1 or D=0 or (−1)). This can be a prompt power detector as one of the two results will give the expected L2C signal power while the other will only contain noise as shown below:
Based on Equation (1), assuming that there is no phase error between the incoming carrier and the local replica carrier, so α=0

$$\begin{matrix}{I}_{prompt} = [ R ( τ ) \sqrt{\frac{P}{2}} {D}_{tx} cos α + {n}_{{I}_{CM}} ] \times {D}_{rx} + R ( τ ) \sqrt{\frac{P}{2}} cos α + {n}_{{I}_{CL}} \\ = R ( τ ) \sqrt{\frac{P}{2}} ( {D}_{tx} \times {D}_{rx} + 1 ) + {n}_{{I}_{CM}} \times {D}_{rx} + {n}_{{I}_{CL}}\end{matrix}$$

For one of the correlation kernels, Dᵣₓ=Dₜₓ, while for the other, Dᵣₓ=−Dₜₓ, so the outputs from the two correlation kernels are:

$$\begin{matrix}H 0 \text{:} {D}_{rx} = - {D}_{tx} & \\ \begin{matrix}{I}_{prompt} = R ( τ ) \sqrt{\frac{P}{2}} ( {D}_{tx} \times {D}_{rx} + 1 ) + {n}_{{I}_{CM}} \times {D}_{rx} + {n}_{{I}_{CL}} \\ = R ( τ ) \sqrt{\frac{P}{2}} ( - 1 + 1 ) + {n}_{{I}_{CM}} \times {D}_{rx} + {n}_{{I}_{CL}} \\ = {n}_{{I}_{CM}} \times {D}_{rx} + {n}_{{I}_{CL}}\end{matrix} & ( 2 ) \\ H 1 \text{:} {D}_{rx} = {D}_{tx} , then & \\ \begin{matrix}{I}_{prompt} = R ( τ ) \sqrt{\frac{P}{2}} ( {D}_{tx} \times {D}_{rx} + 1 ) + {n}_{{I}_{CM}} \times {D}_{rx} + {n}_{{I}_{CL}} \\ = R ( τ ) \sqrt{\frac{P}{2}} ( 1 + 1 ) + {n}_{{I}_{CM}} \times {D}_{rx} + {n}_{{I}_{CL}} \\ = R ( τ ) \sqrt{2 P} + {n}_{{I}_{CM}} \times {D}_{rx} + {n}_{{I}_{CL}}\end{matrix} & ( 3 )\end{matrix}$$

Based on Equations (2) and (3), the problem becomes the detection of a deterministic signal in white Gaussian noise.

Approaches for solving these types of problems can be found in Kay, Steven M., Fundamentals of Statistical Signal Processing, Detection Theory, Chapter 5, Sec. 5, which is incorporated herein by reference.

With the navigation data bit D resolved, the corresponding code phase and carrier phase discriminator can be formed according to U.S. Pat. No. 6,744,404 and sent to the code and carrier tracking loops to drive the local replica to follow that of the incoming signals.

It is to be understood that the invention can be embodied in various forms, and is not to be limited to the examples discussed above. Other components and configurations can be utilized in the practice of the present invention.

Having thus described the invention, what is claimed as new and desired to be secured by Letters Patent is:

1. A Global Navigation Satellite System (GNSS) receiver system adapted for receiving GNSS ranging signals and including a tracking algorithm, which receiver system includes:
a GNSS signal receiver;
a down converter adapted for downconverting a GNSS signal to an intermediate frequency (IF);
a digital sampler adapted for receiving and sampling said down-converted GNSS signal;
a multiplier adapted for multiplying said sampled signals by a local replica of the incoming IF carrier (I reference generator and Q reference generator) for removing Doppler;
first and second parallel correlation kernel modules;
said first parallel correlation kernel assuming the navigation data D=1; and
the second parallel correlation kernel assuming the navigation data D=0 or (−1).

2. The receiver system according to claim 1, which includes:
multiple signal paths corresponding to multiple signal bands respectively.

3. The receiver system according to claim 2 wherein said signal bands include the civilian signal broadcast on the L2 frequency (1227.6 MHz) (L2C).

4. The receiver system according to claim 2 wherein said signal bands include interleaved pseudo-random code.

5. The receiver system according to claim 3, which includes:
L2C being a composite code with civilian moderate length code (CM) modulated with navigation data and dataless civilian long length code (CL).

6. The receiver system according to claim 5, which includes:
CM XOR CNAV data with CL multiplexing.

7. The receiver system according to claim 5, which includes:
CM XOR legacy navigation data with CL multiplexing.

8. The receiver system according to claim 1 wherein the D=1 and the D=−1 alternative waveforms are equally likely and are unpredictable in a real-time receiver.

9. The receiver system according to claim 2 wherein said sampled signals are multiplied by a local replica of the incoming intermediate frequency (IF) carrier provided by an I reference generator and a Q reference generator.

10. The receiver system according to claim 2, which includes:
said signal paths including: a) a civilian moderate (CM) length code generator; b) a civilian long (CL) length code generator; and c) a coarse acquisition (C/A) code generator respectively.

11. The receiver system according to claim 1 wherein said signals are represented by the equations:
$${I}_{prompt} = [ R ( τ ) \sqrt{\frac{P}{2}} {D}_{tx} cos α + {n}_{{I}_{CM}} ] \times {D}_{rx} + R ( τ ) \sqrt{\frac{P}{2}} cos α + {n}_{I \_ CL} \qquad ( 1 )$$
Where:
R(τ) is the normalized correlation function of the CM/CL code, and τ is the delay between the local CM/CL code and that of the incoming. P is the received carrier power at the receiver front end, the ratio of ½ is because the carrier power is equally split between the CM and CL. Dₜₓ is the navigation data (1 or −1) as transmitted by the satellite, Dᵣₓ is the navigation data as assumed by one of the two correlation kernels. Dᵣₓ takes the value of 1 or −1. n_{I}_{_{—}}_{cm} is the noise resulting from the correlation of the local CM code against the incoming signal. n_{I}_{_{—}}_{CL} is the noise resulting from the correlation of the local CL code against the incoming signal, a is the phase error between the incoming carrier and the local replica carrier.
$${Q}_{prompt} = [ R ( τ ) \sqrt{\frac{P}{2}} {D}_{tx} sin α + {n}_{{Q}_{CM}} ] \times {D}_{rx} + R ( τ ) \sqrt{\frac{P}{2}} sin α + {n}_{Q \_ CL}$$
$$\begin{matrix}{I}_{prompt} = [ R ( τ ) \sqrt{\frac{P}{2}} {D}_{tx} cos α + {n}_{{I}_{CM}} ] \times {D}_{rx} + R ( τ ) \sqrt{\frac{P}{2}} cos α + {n}_{{I}_{CL}} \\ = R ( τ ) \sqrt{\frac{P}{2}} ( {D}_{tx} \times {D}_{rx} + 1 ) + {n}_{{I}_{CM}} \times {D}_{rx} + {n}_{{I}_{CL}}\end{matrix}$$
For one of the correlation kernels, Dᵣₓ=Dₜₓ, while for the other, Dᵣₓ=−Dₜₓ, so the outputs from the two correlation kernels are:
$$\begin{matrix}H 0 \text{:} {D}_{rx} = - {D}_{tx} & \\ \begin{matrix}{I}_{prompt} = R ( τ ) \sqrt{\frac{P}{2}} ( {D}_{tx} \times {D}_{rx} + 1 ) + {n}_{{I}_{CM}} \times {D}_{rx} + {n}_{{I}_{CL}} \\ = R ( τ ) \sqrt{\frac{P}{2}} ( - 1 + 1 ) + {n}_{{I}_{CM}} \times {D}_{rx} + {n}_{{I}_{CL}} \\ = {n}_{{I}_{CM}} \times {D}_{rx} + {n}_{{I}_{CL}}\end{matrix} & ( 2 ) \\ H 1 \text{:} {D}_{rx} = {D}_{tx} , then & \\ \begin{matrix}{I}_{prompt} = R ( τ ) \sqrt{\frac{P}{2}} ( {D}_{tx} \times {D}_{rx} + 1 ) + {n}_{{I}_{CM}} \times {D}_{rx} + {n}_{{I}_{CL}} \\ = R ( τ ) \sqrt{\frac{P}{2}} ( 1 + 1 ) + {n}_{{I}_{CM}} \times {D}_{rx} + {n}_{{I}_{CL}} \\ = R ( τ ) \sqrt{2 P} + {n}_{{I}_{CM}} \times {D}_{rx} + {n}_{{I}_{CL}}\end{matrix} & ( 3 )\end{matrix}$$

12. A method of code phase tracking Global Navigation Satellite System (GNSS) composite signals, with one signal assuming D=1 and another signal assuming D=−1, which method comprises the steps of:
providing a receiver system including: a GNSS signal receiver; a down converter connected to the receiver and adapted for down converting a GNSS signal to an intermediate frequency (IF); a digital sampler adapted for receiving and sampling said down-converted GNSS signal; a multiplier adapted for multiplying said sampled signals by a local replica of the incoming IF carrier for removing Doppler;
providing first and second parallel correlation kernel modules;
said first parallel correlation kernel assuming the navigation data D=1; and
the second parallel correlation kernel assuming the navigation data D=0 or (−1).

13. The method according to claim 12, which includes additional steps of:
providing multiple signal paths corresponding to multiple GNSS signal bands respectively.

14. The method according to claim 13 wherein said signal bands include the civilian signal broadcast on the L2 frequency (1227.6 MHz) (L2 C).

15. The method according to claim 12 wherein said signal bands include interleaved pseudo-random code.

16. The method according to claim 12, which includes L2 C being a composite code with civilian moderate length code (CM) modulated with navigation data and dataless civilian long length code (CL).

17. The method according to claim 12, which includes additional step of:
providing CM XOR CNAV data with CL multiplexing.

18. The method according to claim 12, which includes additional step of:
providing CM XOR legacy navigation data with CL multiplexing.

19. The method according to claim 12 wherein the D=1 and the D=−1 alternative waveforms are equally likely and are unpredictable in a real-time receiver.

20. The method according to claim 12 wherein said sampled signals are multiplied by a local replica of the incoming intermediate frequency (IF) carrier provided by an I reference generator and a Q reference generator.

21. The method according to claim 12, which includes:
said signal paths including: a) a civilian moderate (CM) length code generator; b) a civilian long (CL) length code generator; and c) a coarse acquisition (C/A) code generator respectively.

22. The method according to claim 12, which includes:
said signal paths including: a) a civilian moderate (CM) length code generator; b) a civilian long (CL) length code generator; and c) a coarse acquisition (C/A) code generator respectively.
